(19) United States
(12) Patent Application Publication
(10) Pub. No.: US 2009/0180079 A1
(43) Pub. Date: Jul. 16, 2009

(54) Projected Overlay for Copy Degradation

(76) Inventor: Willliam S. Oakley, San Jose, CA (US)

Correspondence Address: TIPS GROUP;c/o Intellevate LLC, P. O. BOX 52050, Minneapolis, MN, 55402, US

(21) Appl. No.: 12/015,505

(22) Filed: Jan. 16, 2008

(51) Int. Cl. G03B 21/26; G02F 1/1335

(52) U.S. Cl. 353/31; 353/121; 359/246

(57) ABSTRACT

In an embodiment, a system is provided. The system includes a visible light projector including a light source, light modulator, and projection optics. The system also includes an infra-red image generator to receive infra-red light from the light source. The system further includes focusing optics coupled to the infra-red image generator to produce an infa-red output beam.

### BACKGROUND

Projection of motion pictures in theatres is still primarily done based on film and projection technology little changed since the dawn of motion pictures. However, compared to film, digital media allows for much easier storage of representations of an image. In order to move beyond film-based projection, it would be useful to provide a digital projector which fits general theater requirements.

Furthermore, a studio consortium has set forth a standard for future digital projection systems. While this standard is by no means final, it provides a rough guide as to what a system must do—what specifications must be met. Thus, it may be useful to provide a digital projection system which meets the standards of the studio consortium.

### BRIEF DESCRIPTION OF THE DRAWINGS

The present invention is illustrated by way of example in the accompanying drawings. The drawings should be understood as illustrative rather than limiting.

FIG. 1 illustrates an embodiment of a display system.

FIG. 2 illustrates another embodiment of a display system.

FIG. 3 illustrates an embodiment of a process of displaying images.

FIG. 4 illustrates an embodiment of displayed images.

FIG. 5 illustrates yet another embodiment of a display system.

FIG. 6 illustrates another embodiment of a process of displaying images.

FIG. 7 illustrates an embodiment of a system using a computer and a projector.

FIG. 8 illustrates an embodiment of a computer which may be used with the projectors of FIGS. 1, 2 and 5, for example.

FIGS. 9A and 9B illustrate an embodiment of a complex polarizing beamsplitter which may be used with the embodiment of FIG. 5, for example.

### DETAILED DESCRIPTION

A system, method and apparatus is provided for a projector using a projected overlay for copy degradation. The specific embodiments described in this document represent exemplary instances of the present invention, and are illustrative in nature rather than restrictive.

In the following description, for purposes of explanation, numerous specific details are set forth in order to provide a thorough understanding of the invention. It will be apparent, however, to one skilled in the art that the invention can be practiced without these specific details. In other instances, structures and devices are shown in block diagram form in order to avoid obscuring the invention.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment, nor are separate or alternative embodiments mutually exclusive of other embodiments.

The availability of small hand held video cameras has enabled unauthorized copying of movies in public theater environments and resulted in illegal DVD's appearing for sale. One approach to reduce the incentive for this activity is to degrade the recorded video such that the DVD later offered for sale is of such poor quality as to substantially reduce or eliminate the sale of illicit DVDs. A possible means of degrading the illegally recorded image is to add an overlay image onto the projected movie image that is invisible to the viewer in the theater, but is recorded by hand held video cameras.

Video cameras separate the image into the blue, green, and red portions of the spectrum for recording and generally use optical pass band filters for this purpose. These filters do not generally have a high level of blocking for portions of the spectrum outside of the visible region. For some cameras a near infra red (IR), image projected onto the screen will be recorded along with the red image, but will be invisible to the unaided human eye. Projected intensities in the infra-red will be sufficiently low at the screen as to hold no risk of eye damage to the theater viewer, but will degrade the image recorded by video cameras. Once recorded along with the red portions of the movie on the ‘red’ image sensor in the video camera, the IR overlay will not be separable and when the captured video is replayed it will appear as a red image superposed on the original movie. The effectiveness of the image degradation technique will vary with the video camera used to capture the illicit image as color separation filters and detectors differ with camera type.

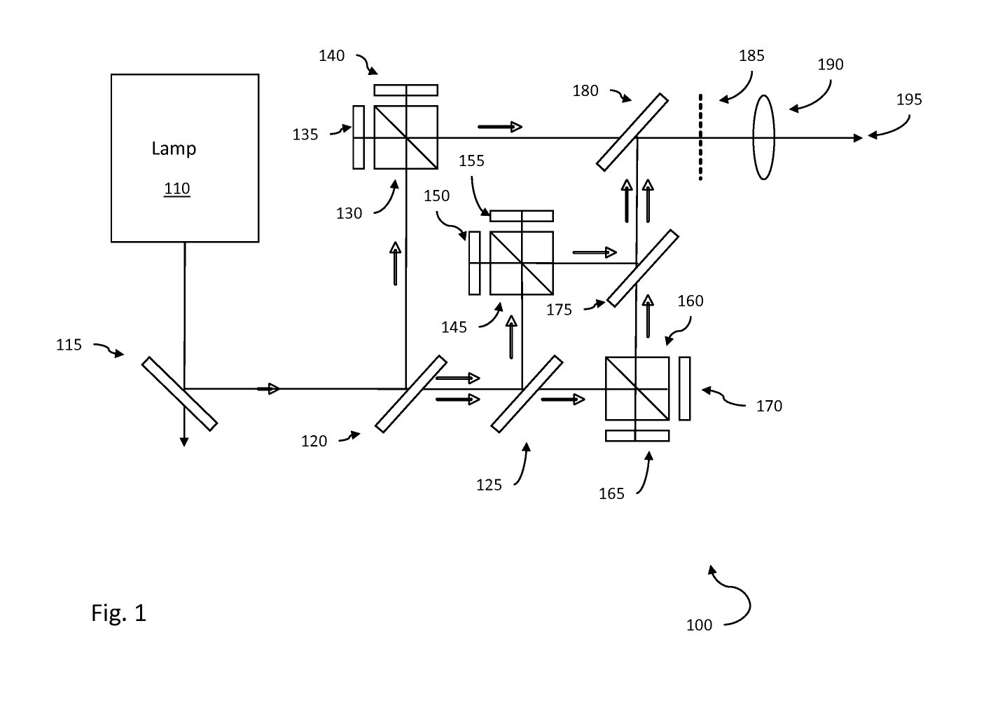

Turning to the specific components of FIG. 1, a high efficiency optical design for three color RGB (red, green, blue) image projectors is shown. This embodiment uses six LCoS image planes to obtain both optical polarizations in all colors and is suitable for slide or dynamic video presentations to large screens. A randomly polarized white light source (110) is stripped of IR and UV components by an IR/UV rejection filter (115) input to a first dichroic mirror (DM1-120) which reflects the blue portion of the spectrum to a polarizing beam splitter (PB1-130). The remainder of the spectrum passes through the dichroic mirror (120) to a second dichroic mirror (DM2-125), which reflects the red portion of the spectrum to a second polarizing beam splitter (PB2-145). The remaining spectrum passes to a third polarizing beam splitter (PB3-160).

Each of the three beam splitters separates its portion of the spectrum into two orthogonal polarization components, each of which is directed to an active LCoS (Liquid Crystal on Silicon) image generation plane (chips 135, 140, 150, 155, 165 and 170). Both polarization components are selectively polarization rotated on a pixel by pixel basis by an electrical signal applied to the LCoS display chips, so as to modulate the input light and impart an image onto the throughput light. Polarization modulated light is reflected from each LCoS chip back through the polarizing beam splitters (130, 145 and 160), so that both polarizations exit from the polarizing beam splitter and are re-combined with similarly processed light of the other spectral portions via dichroic mirrors (175 and 180) to form a white image (at projection lens image plane 185) which is focused on a remote screen using a projection lens (190) to provide output light 195.

Two possible approaches exist in regard to an IR overlay image: one where the false ‘red’ IR image is precisely aligned with the real image, and one where it is not. The first approach is discussed further below. In the second approach the IR image is not accurately registered to the movie image but is simply a low resolution image independently aimed at the movie screen.

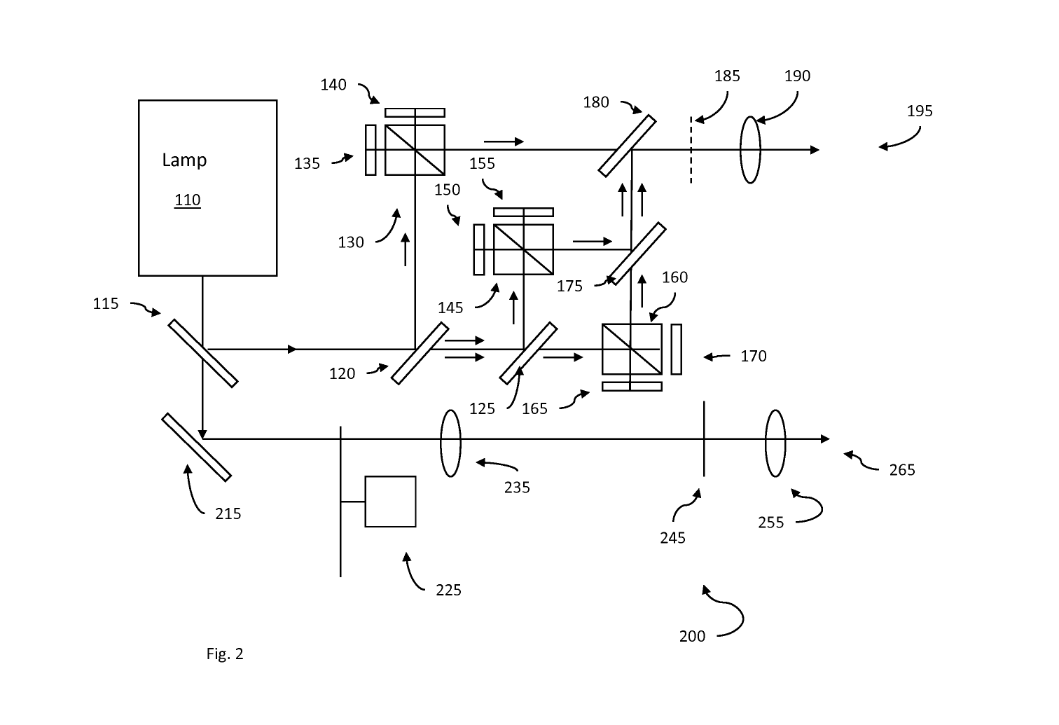

The IR light source for this can be either the same broadband lamp source used in the projector, or a separate lamp. The IR may also be obtained from Light Emitting Diodes (LEDs), or laser diode (LD) sources. Use of a separate IR source would enable IR image projection without the need for customized projectors and would enable use with existing equipment, including standard film projectors. FIG. 2 shows a typical RGB digital projector using LCoS image chips where the IR for the overlay is obtained from the projection lamp. As suggested in the figure, the IR source illuminating the slide can be pulsed at an annoying flicker rate by use of a chopper wheel to interrupt the IR image on the screen.

Turning to FIG. 2, the embodiment illustrated is provided by adding components to the embodiment of FIG. 1. Similar modifications may be made to other projectors to achieve a similar type of functionality. System 200 includes an IR reflector 215, chopper wheel 225, focusing optics 235, IR slide 245, projection optics 255, all of which produce an IR output beam 265. IR reflector 215 reflects IR radiation rejected by rejection optics (filter) 115 through a chopper wheel 225 and into focusing optics 235. Chopper wheel 225 may selectively block or transmit radiation (light), allowing for pulsing of an image without pulsing a light source. Radiation focused by optics 235 is then transmitted through IR slide 245, to form an image—IR slide 245 has a pre-defined image which is imposed on the IR radiation. Projection optics 255 then focus the resulting image for projection on a screen, resulting in projection beam 265, which can be projected on a screen.

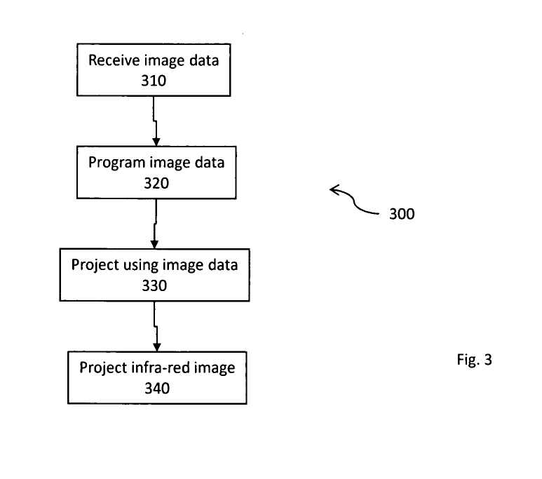

A process of operating a projector such as that of FIG. 2 can be found in FIG. 3. Process 300 includes receiving image data, programming the image data, projecting using the image data, and projecting an infra-red image. Process 300 and other processes of this document are implemented as a set of modules, which may be process modules or operations, software modules with associated functions or effects, hardware modules designed to fulfill the process operations, or some combination of the various types of modules, for example. The modules of process 300 and other processes described herein may be rearranged, such as in a parallel or serial fashion, and may be reordered, combined, or subdivided in various embodiments.

Process 300 begins a cycle at module 310 with receipt of image data for a frame. At module 320, the image data is programmed into the appropriate display device, such as through programming of an LCoS chip (or set of chips), for example. At module 330, projection of an image (using red, green and blue light, for example) occurs using the image data. At module 340, an infra-red image (independent of the image data) is also projected. Thus, modules 330 and 340 may operate simultaneously, for example. Additionally, one may expect process 300 to repeat, such as on a frame-by-frame basis.

Static or pulsed IR images intended to degrade copied video can be obtained by using a lamp, LED, or laser diode (LD) source that projects a fixed image of a slide to the screen. Images such as a ‘skull and cross bones’, a snake, scorpion, or some similar widely recognized symbol or legend are easily projected. More complex legends could include the identification of the cinema from which the image was taken and perhaps the time and date of recording.

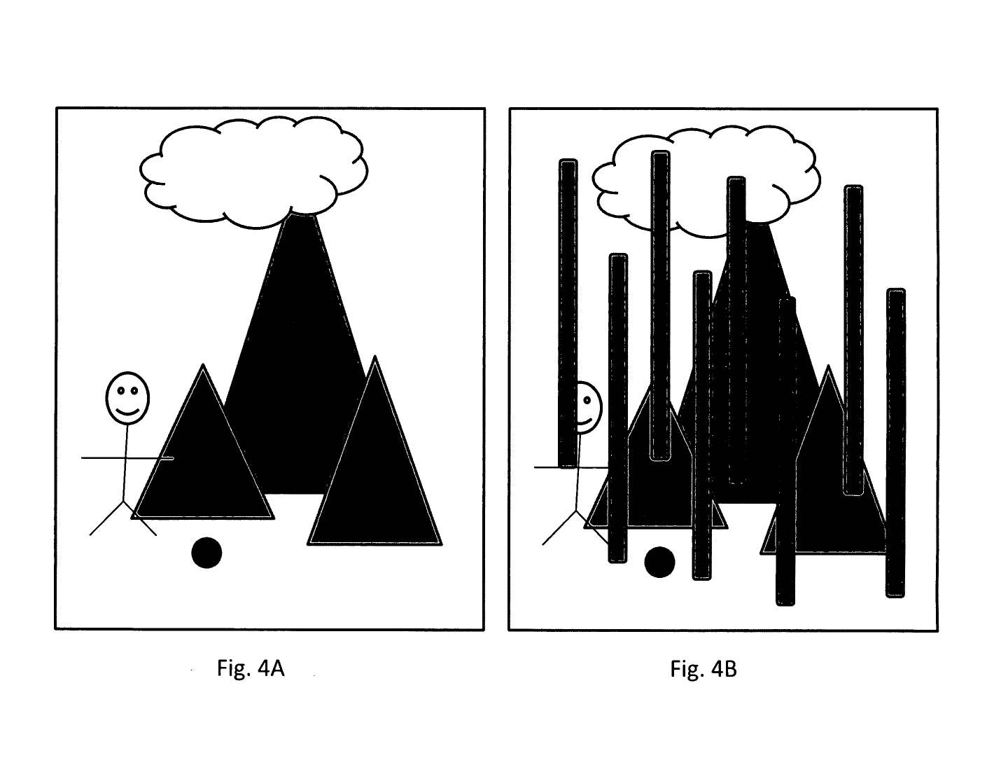

An example of an original image and a degraded image can be found in FIG. 4. FIG. 4A illustrates an image which may be projected on a screen. FIG. 4B illustrates another image, in which red bars are superimposed on the image of FIG. 4A. In such an image, the red bars may be projected at infra-red (IR) images. When the projected image is recorded by a video-recorder that does not filter out near-IR, the IR image will likely be recorded as red, and thus will play back as red rather than IR. Thus, the recorded image will appear to be that of FIG. 4B, even though the image visible on the screen to most viewers was that of FIG. 4A at the time of the recording.

For both dynamic and static IR overlays using LED or LD sources the degree of image degradation can be enhanced by pulsing the IR image at the eye response rate, at about 8-10 Hertz. This would cause the illicit image to flicker at an annoying rate when replayed. Additionally, to maximize the IR intensity on the screen for a given laser diode source an image could be projected using a hologram, or computer generated hologram (CGH). Alternately, a group of IR LEDs could be imaged onto the projection screen and moved around by prisms or mirrors to produce a similar effect. Switching the LEDs randomly on and off would produce the effect of a swarm of fireflies on the screen.

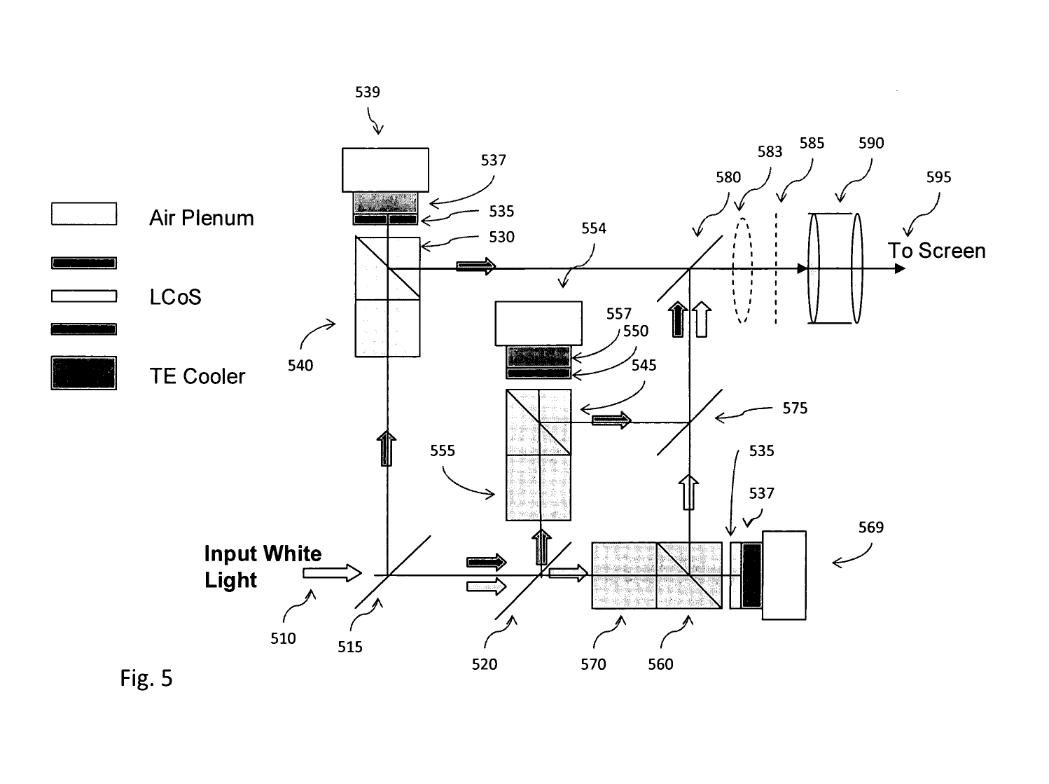

In an embodiment using polarization combining optics to reduce the number of LCoS image chips to three as shown in FIG. 5, one may provide a projection system with fewer LCoS chips. Thus, FIG. 5 provides an illustration of another embodiment of an LCoS image projector. A randomly polarized white light source (510) is stripped of IR and UV components by an IR/UV rejection filter (515) input to a first dichroic mirror (515) which reflects the blue portion of the spectrum to a half-wave plate 540 and a polarizing beam splitter (530). The remainder of the spectrum passes through the dichroic mirror (515) to a second dichroic mirror (520), which reflects the red portion of the spectrum to a second half wave plate 555 and polarizing beam splitter (545). The remaining spectrum passes to a third half wave plate 570 and polarizing beam splitter (560).

Each of the three beam splitters separates its portion of the spectrum into two orthogonal polarization components, one of which is directed to an active LCoS (Liquid Crystal on Silicon) image generation plane (chips 535, 550 and 565). Both polarization components are selectively polarization rotated on a pixel by pixel basis by an electrical signal applied to the LCoS display chips, so as to modulate the input light and impart an image onto the throughput light. The half wave plates 540, 555 and 570 may be electronically controlled to determine whether light (polarization) is rotated or not, allowing for output of both polarizations on a sequential basis.

Polarization modulated light is reflected from each LCoS chip back through the polarizing beam splitters (530, 545 and 560), so that both polarizations exit from the polarizing beam splitter and are re-combined with similarly processed light of the other spectral portions via dichroic mirrors (575 and 580) to form a white image (at projection lens image plane 585) which is focused on a remote screen using a projection optics (590) to provide output light 595. Focusing to plane 585 may involve additional optics 583. Furthermore, each of LCoS chips 535, 550 and 565 are provided with a TEC (537, 552 and 567 respectively) and associated air plenum (539, 554 and 568 respectively) to provide cooling.

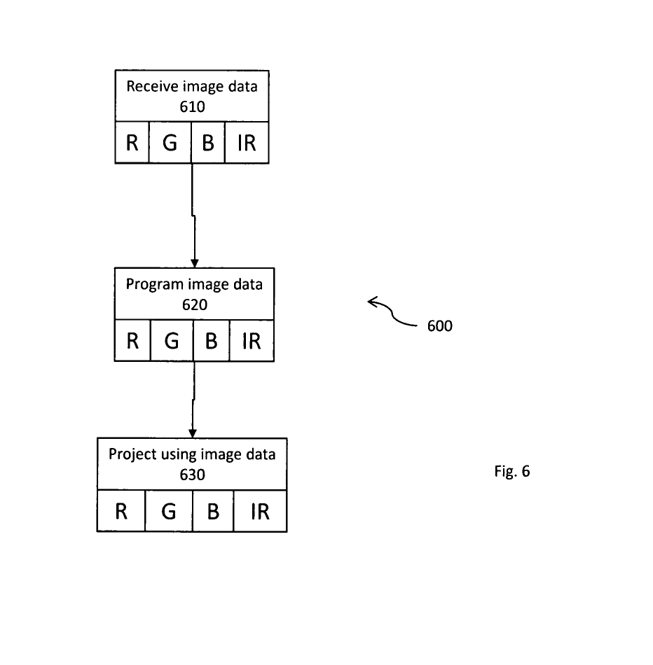

One may add a fourth set of optics and LCoS chips to the embodiment of FIG. 5 in order to provide IR projection capabilities. Similarly, one may add a fourth set of optics and LCoS chips to the embodiment of FIG. 1 to implement IR projection, too. A process of operating such a device is provided in the illustration of FIG. 6.

FIG. 6 provides an illustration of an embodiment of a process of operating a projector with IR capabilities. Process 600 includes receiving image data, programming the image data, and projecting based on the image data. Process 600 begins its cycle at module 610 with receipt of image data. This image data is then programmed into a modulation component, such as an LCoS chip or set of chips in a display at module 620. At module 630, the projector displays an image based on the programmed image data. In the case of a projector with IR capabilities, image data may be expected to arrive with four components, for red (R), green (G), blue (B) and infra-red (IR). Each may be programmed into individual modulation components, or sequentially programmed into a single modulation component, for example. Thus, a projected image with an IR component can be provided. In applications where IR projection is desired, such as simulation of night vision conditions for example, this can be perceptible to viewers of the projection.

In such circumstances, in addition to the copy degradation aspects of the IR image, some applications exist where an accurately positioned dynamic IR image overlay is desired for training purposes. These applications include circumstances where IR sources are intentionally simulated for detection by IR sensitive night vision devices or thermal viewing devices. Depending on the application and effects desired, IR images can be projected as dynamic video, pulsed non-dynamic images, or as static images. For dynamic images generated from digital video using RGB image chips such as in LCoS projectors the IR image is obtained by adding a fourth image chip.

The four chip projector could also be used for image degradation as this would allow, for example, the inverse of the red image to be shown in the IR so the illicit recorded image would show the red frame as of uniform brightness, causing the illicit video to show only blue and green frames, causing false colors and reducing image contrast. E.g., a formerly red object will appear black, and a formerly blue-green scene will appear white. Alternatively the green or blue image portions could be projected in the IR, and the scene would then show as red on top of the blue or green, generating odd colors, or the inverse image displayed could vary in a random sequence.

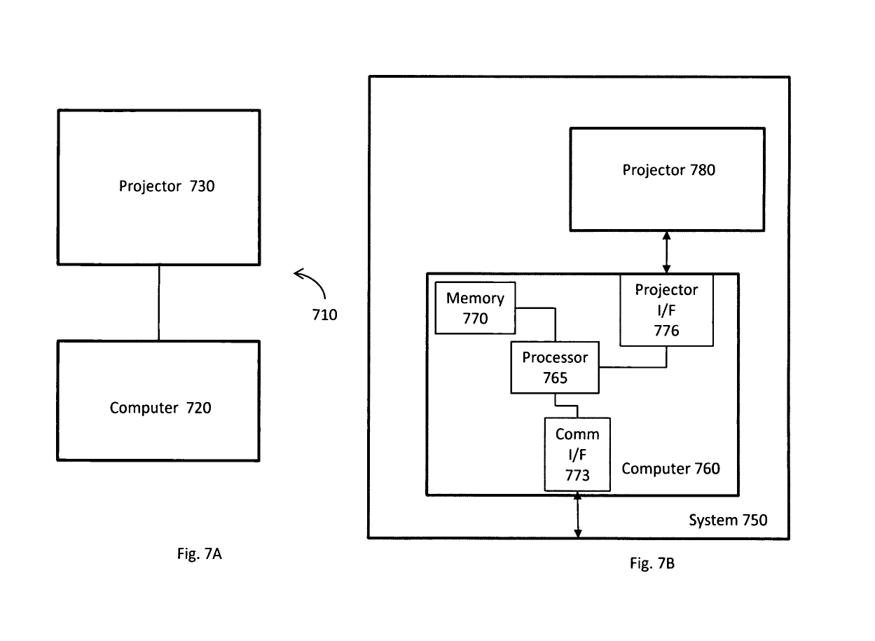

The overall system used with various implementations may also be instructive. FIG. 7A illustrates an embodiment of a system using a computer and a projector. System 710 includes a conventional computer 720 coupled to a digital projector 730. Thus, computer 720 can control projector 730, providing essentially instantaneous image data from memory in computer 720 to projector 730. Projector 730 can use the provided image data to determine which pixels of included LCoS display chips are used to project an image. Additionally, computer 720 may monitor conditions of projector 730, and may initiate active control to shut down an overheating component or to initiate startup commands for projector 730.

FIG. 7B illustrates another embodiment of a system using a computer and projector. System 750 includes computer subsystem 760 and optical subsystem 780 as an integrated system. Computer 760 is essentially a conventional computer with a processor 765, memory 770, an external communications interface 773 and a projector communications interface 776.

The external communications interface 773 may use a proprietary (a standard developed for such a device but not publicized by its developer), or a publicly available communications standard, and may be used to receive both digital image data and commands from a user. The projector communications interface 776 provides for communication with projector subsystem 780, allowing for control of LCoS chips (not shown) included in projector subsystem 780, for example. Thus, projector communications interface 776 may be implemented with cables coupled to LCoS chips, or with other communications technology (e.g. wires or traces on a printed circuit board) coupled to included LCoS chips. Other components of computer subsystem 760, such as dedicated user input and output modules, may be included, depending on the needs for functionality of a conventional computer system in system 750. System 750 may be used as an integrated, standalone system—thus allowing for the possibility that each theater may use its own projector with a built-in control system, for example.

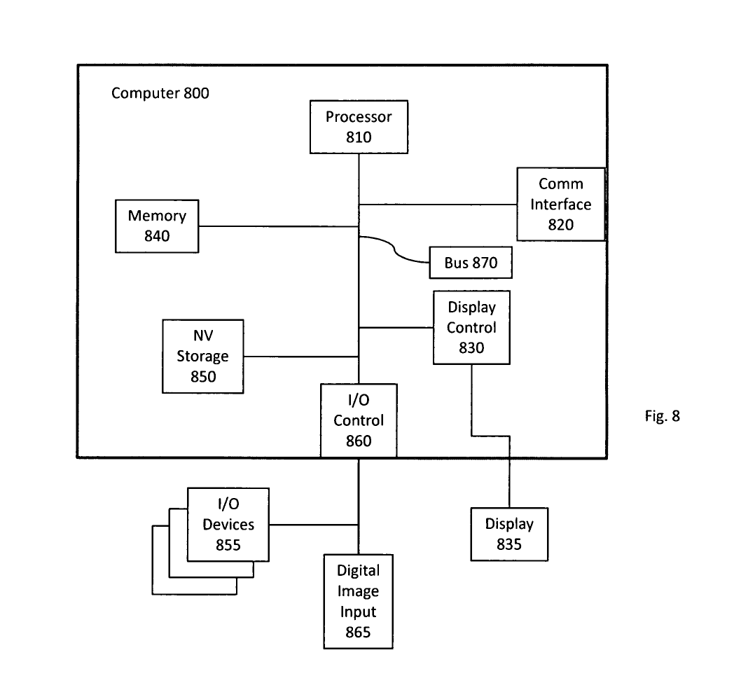

FIG. 8 illustrates an embodiment of a computer which may be used with the projectors of FIGS. 1, 2 and 5, for example. The following description of FIG. 8 is intended to provide an overview of computer hardware and other operating components suitable for performing the methods of the invention described above and hereafter, but is not intended to limit the applicable environments. Similarly, the computer hardware and other operating components may be suitable as part of the apparatuses and systems of the invention described above. The invention can be practiced with other computer system configurations, including hand-held devices, multiprocessor systems, microprocessor-based or programmable consumer electronics, network PCs, minicomputers, mainframe computers, and the like. The invention can also be practiced in distributed computing environments where tasks are performed by remote processing devices that are linked through a communications network.

FIG. 8 shows one example of a conventional computer system that can be used as a client computer system or a server computer system or as a web server system. The computer system 800 interfaces to external systems through the modem or network interface 820. It will be appreciated that the modem or network interface 820 can be considered to be part of the computer system 800. This interface 820 can be an analog modem, isdn modem, cable modem, token ring interface, satellite transmission interface (e.g. “direct PC”), or other interfaces for coupling a computer system to other computer systems. In the case of a closed network, a hardwired physical network may be preferred for added security.

The computer system 800 includes a processor 810, which can be a conventional microprocessor such as microprocessors available from Intel or Motorola. Memory 840 is coupled to the processor 810 by a bus 870. Memory 840 can be dynamic random access memory (dram) and can also include static ram (sram). The bus 870 couples the processor 810 to the memory 840, also to non-volatile storage 850, to display controller 830, and to the input/output (I/O) controller 860.

The display controller 830 controls in the conventional manner a display on a display device 835 which can be a cathode ray tube (CRT) or liquid crystal display (LCD). Display controller 830 can, in some embodiments, also control a projector such as those illustrated in FIGS. 1 and 5, for example. The input/output devices 855 can include a keyboard, disk drives, printers, a scanner, and other input and output devices, including a mouse or other pointing device. The input/output devices may also include a projector such as those in FIGS. 1 and 5, which may be addressed as an output device, rather than as a display. The display controller 830 and the I/O controller 860 can be implemented with conventional well known technology. A digital image input device 865 can be a digital camera which is coupled to an i/o controller 860 in order to allow images from the digital camera to be input into the computer system 800. Digital image data may be provided from other sources, such as portable media (e.g. FLASH drives or DVD media).

The non-volatile storage 850 is often a magnetic hard disk, an optical disk, or another form of storage for large amounts of data. Some of this data is often written, by a direct memory access process, into memory 840 during execution of software in the computer system 800. One of skill in the art will immediately recognize that the terms “machine-readable medium” or “computer-readable medium” includes any type of storage device that is accessible by the processor 810 and also encompasses a carrier wave that encodes a data signal.

The computer system 800 is one example of many possible computer systems which have different architectures. For example, personal computers based on an Intel microprocessor often have multiple buses, one of which can be an input/output (I/O) bus for the peripherals and one that directly connects the processor 810 and the memory 840 (often referred to as a memory bus). The buses are connected together through bridge components that perform any necessary translation due to differing bus protocols.

Network computers are another type of computer system that can be used with the present invention. Network computers do not usually include a hard disk or other mass storage, and the executable programs are loaded from a network connection into the memory 840 for execution by the processor 810. A Web TV system, which is known in the art, is also considered to be a computer system according to the present invention, but it may lack some of the features shown in FIG. 8, such as certain input or output devices. A typical computer system will usually include at least a processor, memory, and a bus coupling the memory to the processor.

In addition, the computer system 800 is controlled by operating system software which includes a file management system, such as a disk operating system, which is part of the operating system software. One example of an operating system software with its associated file management system software is the family of operating systems known as Windows® from Microsoft Corporation of Redmond, Wash., and their associated file management systems. Another example of an operating system software with its associated file management system software is the Linux operating system and its associated file management system. The file management system is typically stored in the non-volatile storage 850 and causes the processor 810 to execute the various acts required by the operating system to input and output data and to store data in memory, including storing files on the non-volatile storage 850.

Some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention, in some embodiments, also relates to apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-roms, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear from the description below. In addition, the present invention is not described with reference to any particular programming language, and various embodiments may thus be implemented using a variety of programming languages.

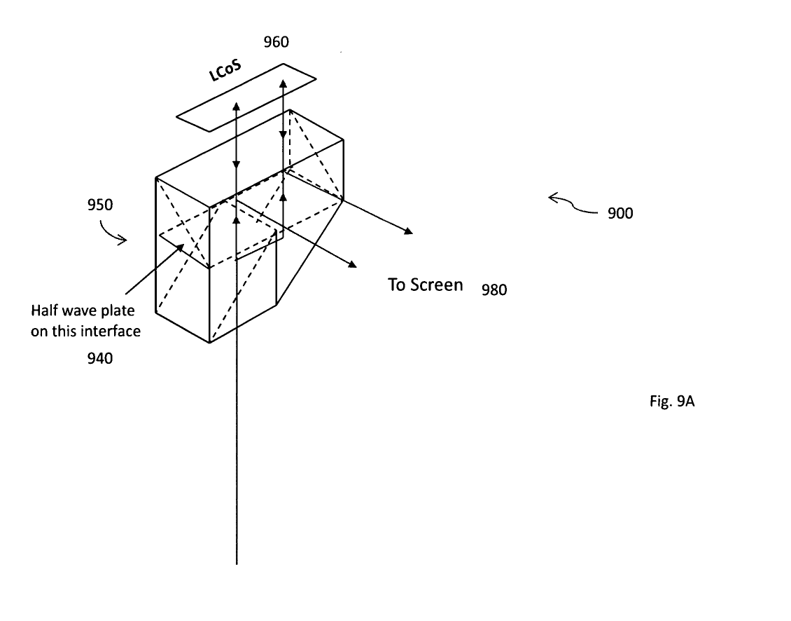

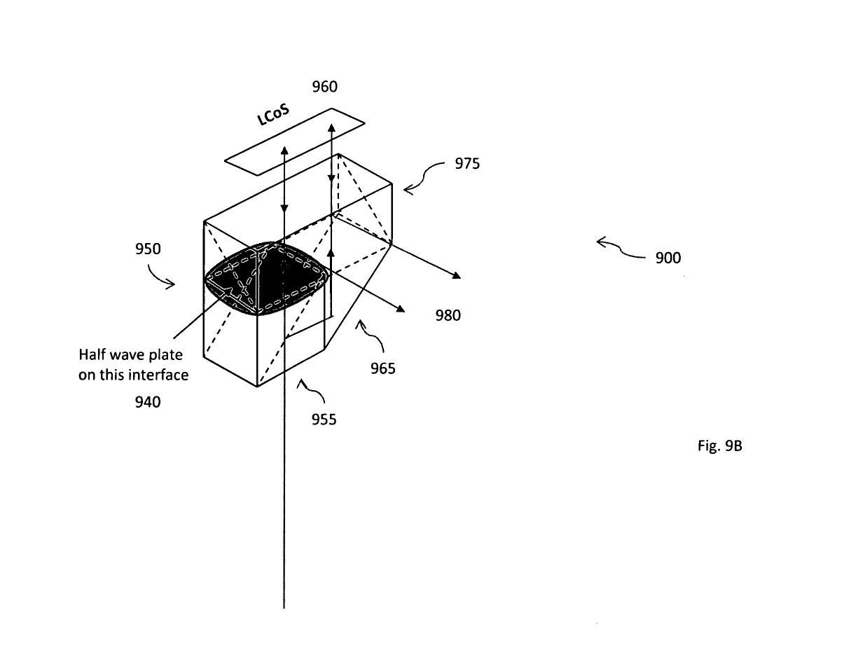

At least one of the optical elements discussed previously bears further discussion. FIGS. 9A and 9B illustrate an embodiment of a complex polarizing beamsplitter which may be used with the embodiment of FIG. 5, for example. Various display systems using various light sources can be configured using a single image generation chip (LCoS) with maximum light efficiency if both polarizations from the light sources can be directed to the same image chip. This can be accomplished by means of a polarization combining prism which separates an input beam into two polarizations, and rotates one to be oriented similarly to the other. The two halves of the input beam illuminate the two halves of an image generating chip (or other reflective optical component) as shown in FIG. 9A. A single polarization beam splitter would suffice if half the light from the light source were not used, but this allows for greater efficiency.

Using a light source similar to that of FIG. 1, one can interpose a more complex polarization beam splitter between the light source and an LCoS chip 960 in display system 900, resulting in creation of two output beams with the same polarization. Beam splitter 950 splits a beam into two beams with the same polarization state. By including a half-wave plate 940 at an interface within the beam splitter 950, one of the beams (the beam passing through the half-wave plate) is polarization rotated to the same state as the other (the beam passing through the mirror and around the half-wave plate) so each beam illuminates a different half of the LCoS chip with the same polarization. Note that the half-wave plate 940 extends only through half of the interface with beam splitter 950—thus it only interacts with one of the beams and has no effect on the other beam. The result is two beams directed at the LCoS chip 960 with the same polarization. The resulting output beams 980 are then directed at a screen, potentially through further projection optics. Note that LCoS chip 960 may need to have twice the width of the LCoS chips 160 of FIG. 1, to accommodate the two beams from beam splitter 950. Alternatively, a lower resolution image can be produced using half of one LCoS chip 160 for each beam.

FIG. 9B further illustrates the complex polarization beam splitter 950. Prism 955 receives light from a light source, and splits it into two light beams having orthogonal polarization states. Mirror 965 reflects one beam with a first polarization state upward (in this perspective). Half wave plate 940 rotates the polarization state of the other beam from a second polarization state to the first polarization state. As a result, two beams are transmitted through prism 975 to a reflective optical component, such as LCoS 960, with each having the same polarization state. Note that whether the first or second polarization state is chosen is not material. The reflective component then reflects light back (potentially modulated for an image) through prism 975, which reflects the light from the reflective optical component 960 as output light 980.

Further consideration of various embodiments may prove helpful. In an embodiment, a system is provided. The system includes a visible light projector including a light source, light modulator, and projection optics. The system also includes an infra-red image generator to receive infra-red light from the light source. The system further includes focusing optics coupled to the infra-red image generator to produce an infa-red output beam.

In various embodiments, The light modulator may be a first LCoS assembly, a second LCoS assembly and a third LCoS assembly, each coupled to optical elements to receive light from the light source and each coupled to the projection optics to produce a visible light output beam. The optical elements may include an infra-red rejection filter interposed between the light modulator and the light source. Moreover, the optical elements may further include a first dichroic mirror interposed between the infra-red rejection filter and the first LCoS assembly and a second dichroic mirror interposed between the first dichroic mirror and each of the second LCoS assembly and the third LCoS assembly. The infra-red image generator may include an infra-red LCoS assembly.

In some embodiments, the system may further include a chopper wheel interposed between the infra-red image generator and the light source. The system may likewise include an infra-red image generator that includes a patterned slide. Moreover, the system may include an infra-red LCoS assembly that generates a pattern displaying a location identifier and date code in the infra-red output beam. In other embodiments, the patterned slide includes a location identifier.

In some embodiments, each LCoS assembly includes a polarization beam splitter, a first LCoS chip coupled to the polarization beam splitter to receive light of a first polarization and a second LCoS chip coupled to the polarization beam splitter to receive light of a second polarization. In some embodiments, the infra-red LCoS assembly generates images for use in conjunction with night-vision equipment.

In another embodiment, a method is presented. The method includes projecting a conventional image in a visible light spectrum. The method further includes projecting an infra-red image simultaneously in an infra-red spectrum. The method may further include interrupting a light source for the projecting of the infra-red image.

The method may also include projecting an infra-red image that obscures the conventional images when both images are perceived. Likewise, the infra-red image may be an identifier of a date and location of projection. Similarly, the infra-red image may be an identifier of a location of projection. Moreover, the infra-red image may be an image for perception by night-vision apparatus. Additionally, the infra-red image may be a Jolly Roger pirate flag.

In yet another embodiment, a system is presented. The system includes a housing. The system further includes a first LCoS assembly coupled to the housing. The first LCoS assembly includes a polarization beam splitter coupled optically to a first LCoS chip and a second LCoS chip. The first LCoS chip is to receive and modulate light of a first polarization and the second LCoS chip is to receive and modulate light of a second polarization. The first LCoS assembly further includes a first heat sink mounted on the first LCoS chip and a second heat sink mounted on the second LCoS chip.

The system further includes a second LCoS assembly coupled to the housing. The second LCoS assembly includes a polarization beam splitter coupled optically to a first LCoS chip and a second LCoS chip. The first LCoS chip is to receive and modulate light of a first polarization. The second LCoS chip is to receive and modulate light of a second polarization. The second LCoS assembly further includes a first heat sink mounted on the first LCoS chip and a second heat sink mounted on the second LCoS chip. The system also includes a third LCoS assembly coupled to the housing. The third LCoS assembly includes a polarization beam splitter coupled optically to a first LCoS chip and a second LCoS chip. The first LCoS chip is to receive and modulate light of a first polarization and the second LCoS chip is to receive and modulate light of a second polarization. The third LCoS assembly further includes a first heat sink mounted on the first LCoS chip and a second heat sink mounted on the second LCoS chip.

The system further includes a coolant circulation system coupled to the housing and coupled to the heat sinks of the first, second and third LCoS assemblies. The system also includes a first beam splitter and a second beam splitter both coupled to the housing. The first beam splitter is arranged to split incoming light between the first LCoS assembly and the second beam splitter. The second beam splitter is arranged to split incoming light between the second LCoS assembly and the third LCoS assembly. The system also includes an IR/UV rejection optical component disposed between the light source and the first beam splitter.

The system further includes a first dichroic mirror and a second dichroic mirror both coupled to the housing. The first dichroic mirror is arranged to receive light from the first LCoS assembly and the second LCoS assembly. The second dichroic mirror is arranged to receive light from the first beam recombiner and from the third LCoS assembly. The system also includes a first light source to provide incoming light to the first beam splitter. The system further includes an output optics element coupled to the housing and arranged to receive light from the second dichroic mirror and to focus an output light source.

The system further includes an infra-red image generator coupled to the housing to receive infra-red light from the light source. The system also includes focusing optics coupled to the housing and coupled to the infra-red image generator to produce an infra-red output beam. The system further includes a processor, a memory coupled to the processor, and a bus coupled to the memory and the processor. The system also includes a communications path between the processor and each of the first and second LCoS chips of the first, second and third LCoS assemblies. The system further includes an interface coupled to the processor, the interface to receive data from a source external to the system.

The infra-red image generator may include (in some embodiments) an infra-red LCoS assembly. The infra-red LCoS assembly may include a polarization beam splitter coupled optically to a first LCoS chip and a second LCoS chip. The first LCoS chip is to receive and modulate light of a first polarization and the second LCoS chip is to receive and modulate light of a second polarization. The second LCoS assembly further includes a first heat sink mounted on the first LCoS chip and a second heat sink mounted on the second LCoS chip. The infra-red image generator may also include a chopper wheel and a patterned slide, each coupled to the housing and coupled to receive the infra-red light from the light source and modulate the infra-red light.

One skilled in the art will appreciate that although specific examples and embodiments of the system and methods have been described for purposes of illustration, various modifications can be made without deviating from present invention. For example, embodiments of the present invention may be applied to many different types of databases, systems and application programs. Moreover, features of one embodiment may be incorporated into other embodiments, even where those features are not described together in a single embodiment within the present document.

1. A system, comprising:
A visible light projector including a light source, light modulator, and projection optics;
An infra-red image generator to receive infra-red light from the light source;
And
Focusing optics coupled to the infa-red image generator to produce an infra-red output beam.

2. The system of claim 1, wherein:
The light modulator is a first LCoS assembly, a second LCoS assembly and a third LCoS assembly, each coupled to optical elements to receive light from the light source and each coupled to the projection optics to produce a visible light output beam.

3. The system of claim 2, wherein:
The optical elements include an infra-red rejection filter interposed between the light modulator and the light source;
And
The optical elements further include a first dichroic mirror interposed between the infra-red rejection filter and the first LCoS assembly and a second dichroic mirror interposed between the first dichroic mirror and each of the second LCoS assembly and the third LCoS assembly.

4. The system of claim 2, wherein:
The infra-red image generator includes an infra-red LCoS assembly.

5. The system of claim 2, further comprising:
A chopper wheel interposed between the infra-red image generator and the light source.

6. The system of claim 6, wherein:
The infra-red image generator includes a patterned slide.

7. The system of claim 4, wherein:
The infra-red LCoS assembly generates a pattern displaying a location identifier and date code in the infra-red output beam.

8. The system of claim 4, wherein:
Each LCoS assembly includes a polarization beam splitter, a first LCoS chip coupled to the polarization beam splitter to receive light of a first polarization and a second LCoS chip coupled to the polarization beam splitter to receive light of a second polarization.

9. The system of claim 4, wherein:
The infra-red LCoS assembly generates images for use in conjunction with night-vision equipment.

10. The system of claim 6, wherein:
The patterned slide includes a location identifier.

11. A method, comprising:
Projecting a conventional image in a visible light spectrum;
Projecting an infra-red image simultaneously in an infra-red spectrum.

12. The method of claim 11, wherein:
The infra-red image obscures the conventional images when both images are perceived.

13. The method of claim 11, wherein:
The infra-red image is an identifier of a date and location of projection.

14. The method of claim 11, wherein:
The infra-red image is an identifier of a location of projection.

15. The method of claim 11, wherein:
The infra-red image is an image for perception by night-vision apparatus.

16. The method of claim 11, wherein:
The infra-red image is a jolly roger pirate flag.

17. The method of claim 11, further comprising:
Interrupting a light source for the projecting of the infra-red image.

18. A system comprising:
A housing;
A first LCoS assembly coupled to the housing, the first LCoS assembly includes a polarization beam splitter coupled optically to a first LCoS chip and a second LCoS chip, the first LCoS chip to receive and modulate light of a first polarization and the second LCoS chip to receive and modulate light of a second polarization, and the first LCoS assembly further includes a first heat sink mounted on the first LCoS chip and a second heat sink mounted on the second LCoS chip;
A second LCoS assembly coupled to the housing, the second LCoS assembly includes a polarization beam splitter coupled optically to a first LCoS chip and a second LCoS chip, the first LCoS chip to receive and modulate light of a first polarization and the second LCoS chip to receive and modulate light of a second polarization, and the second LCoS assembly further includes a first heat sink mounted on the first LCoS chip and a second heat sink mounted on the second LCoS chip;
A third LCoS assembly coupled to the housing, the third LCoS assembly includes a polarization beam splitter coupled optically to a first LCoS chip and a second LCoS chip, the first LCoS chip to receive and modulate light of a first polarization and the second LCoS chip to receive and modulate light of a second polarization, and the third LCoS assembly further includes a first heat sink mounted on the first LCoS chip and a second heat sink mounted on the second LCoS chip;
A coolant circulation system coupled to the housing and coupled to the heat sinks of the first, second and third LCoS assemblies;
A first beam splitter and a second beam splitter both coupled to the housing, the first beam splitter arranged to split incoming light between the first LCoS assembly and the second beam splitter, the second beam splitter arranged to split incoming light between the second LCoS assembly and the third LCoS assembly;
An IR/UV rejection optical component disposed between the light source and the first beam splitter;
A first dichroic mirror and a second dichroic mirror both coupled to the housing, the first dichroic mirror arranged to receive light from the first LCoS assembly and the second LCoS assembly, the second dichroic mirror arranged to receive light from the first beam recombiner and from the third LCoS assembly;
A first light source to provide incoming light to the first beam splitter;
An output optics element coupled to the housing and arranged to receive light from the second beam recombiner and to focus an output light source;
An infra-red image generator coupled to the housing to receive infra-red light from the light source;
Focusing optics coupled to the housing and coupled to the infra-red image generator to produce an infra-red output beam;
A processor;
A memory coupled to the processor;
A bus coupled to the memory and the processor;
A communications path between the processor and each of the first and second LCoS chips of the first, second and third LCoS assemblies;
And
An interface coupled to the processor, the interface to receive data from a source external to the system.

19. The system of claim 18, wherein:
The infra-red image generator includes an infra-red LCoS assembly, the infra-red LCoS assembly includes a polarization beam splitter coupled optically to a first LCoS chip and a second LCoS chip, the first LCoS chip to receive and modulate light of a first polarization and the second LCoS chip to receive and modulate light of a second polarization, and the second LCoS assembly further includes a first heat sink mounted on the first LCoS chip and a second heat sink mounted on the second LCoS chip.

20. The system of claim 18, wherein:
The infra-red image generator includes a chopper wheel and a patterned slide, each coupled to the housing and coupled to receive the infra-red light from the light source and modulate the infra-red light.
